(19) United States
(12) Patent Application Publication
(10) Pub. No.: US 2024/0328817 A1
(43) Pub. Date: Oct. 3, 2024

(54) METHOD OF DYNAMICALLY UPDATING POINTS OF INTEREST, ELECTRONIC MAP SYSTEM AND CLOUD SERVER DEVICE

(71) Applicant: OmniEyes Co., Ltd. Taiwan Branch, Taipei City (TW)

(72) Inventors: Ren-Jie PAN, Taipei City (TW); Yi-Yen WANG, Taipei City (TW); Chun-Ting CHOU, Taipei City (TW)

(21) Appl. No.: 18/194,202

(22) Filed: Mar. 31, 2023

(51) Int. Cl. G01C 21/00; G06T 7/00; G06T 7/73; G06V 10/94; G06V 20/10

(52) U.S. Cl. CPC G01C 21/3811; G01C 21/3841; G06T 7/0002; G06T 7/74; G06V 10/95; G06V 20/182

(57) ABSTRACT

A method of dynamically updating points of interest (POIs) for applied to an electronic map system is provided. The method of dynamically updating POIs includes obtain a plurality of street view images and location information of the plurality of street view images captured by a plurality of edge devices, analyzing the plurality of street view images and the location information of the plurality of street view images according to an artificial intelligence model to determine a plurality of current POIs and locations of the plurality of current POIs, and comparing the plurality of current POIs with a plurality of original POIs stored in a POI database of the electronic map system to perform a POI update procedure.

### FIELD OF THE INVENTION

The invention relates to a method of dynamically updating points of interest, an electronic map system and a cloud server device, and more particularly, to a method of dynamically updating points of interest, an electronic map system and a cloud server device based on street view images.

### BACKGROUND OF THE INVENTION

With the development of information technology, an electronic map has become one of the most frequently used tools in daily life. The electronic map is a map which may be digitally stored using computer technology for access. A point of interest (POI) is a specific place or point location on the electronic map that someone may find useful or interesting. The user can find and select the desired POI from the electronic map according to the requirements. Through the indication of the POI on the electronic map, the driver of the vehicle can know where the traffic signal is and how many lanes there are on the road. Through the indication of the POI on the electronic map, the user can know where the POI is and what the appearance of the POI is. The user can also use the street view function to see the exterior of the building or signboard. In order to keep the electronic map available to meet the requirements of the users, POIs on the electronic map must be updated regularly. For example, a map service company may allow the user to create, modify or delete data of the map. When finding the outdated information on the electronic map or the electronic map is incorrect, the user can report the problem to the map service company. Further, current map service companies, such as Google, may use street view cars to collect driving videos, and humans annotate POIs on the map after watching the driving videos. However, these solutions all require to manually annotate information of the POIs on the electronic map to keep the map up-to-date. Besides, the users usually do not upload dashcam videos, so the street view car still need to actually drive down the street for collecting driving videos. As a result, conventional map updating methods rely on active human efforts, thus requiring a significant amount of time and manual labor to achieve the desired results. Thus, there is a need for improvement.

### SUMMARY OF THE INVENTION

It is therefore an objective of the present invention to provide a method of dynamically updating points of interest, an electronic map system and a cloud server device based on street view images to solve the abovementioned problem.

An embodiment of the present invention discloses a method of dynamically updating points of interest (POIs), applied to an electronic map system, comprising: obtaining a plurality of street view images captured by a plurality of edge devices and location information of the plurality of street view images; analyzing the plurality of street view images and the location information of the plurality of street view images according to an artificial intelligence (AI) model to determine a plurality of current POIs and locations of the plurality of current POIs; and comparing the plurality of current POIs with a plurality of original POIs stored in a POI database of the electronic map system to perform a POI update procedure.

An embodiment of the present invention discloses an electronic map system, comprising: a plurality of edge devices, each edge device disposed on a vehicle and configured to capture street view images and location information of the plurality of street view images; a cloud server device, comprising: an image database, configured to store a plurality of street view images and location information of the plurality of street view images uploaded by the plurality of edge devices; a POI database, configured to store a plurality of original POIs and location information of the plurality of original POIs; an AI processor comprising an AI model, and configured to analyze the plurality of street view images and the location information of the plurality of street view images uploaded by the plurality of edge devices according to the AI model to determine a plurality of current POIs and locations of the plurality of current POIs store a plurality of street view images; and a POI updating circuit, coupled to the POI database and the AI processor, and configured to compare the plurality of current POIs with the plurality of original POIs to perform a POI update procedure.

An embodiment of the present invention discloses a cloud server device, comprising: an image database, configured to store a plurality of street view images and location information of the plurality of street view images uploaded by a plurality of edge devices; a POI database, configured to store a plurality of original POIs and location information of the plurality of original POIs; an AI processor comprising an AI model, and configured to analyze the plurality of street view images and the location information of the plurality of street view images uploaded by the plurality of edge devices according to the AI model to determine a plurality of current POIs and locations of the plurality of current POIs store a plurality of street view images; and a POI updating circuit, coupled to the POI database and the AI processor, and configured to compare the plurality of current POIs with the plurality of original POIs to perform a POI update procedure.

### BRIEF DESCRIPTION OF THE DRAWINGS

FIG. 1 is a schematic diagram of an electronic map system 1 capable of dynamically updating POIs according to an embodiment of the present invention.

FIG. 2 is a flow diagram of a procedure according to an embodiment of the present invention.

### DETAILED DESCRIPTION OF THE INVENTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

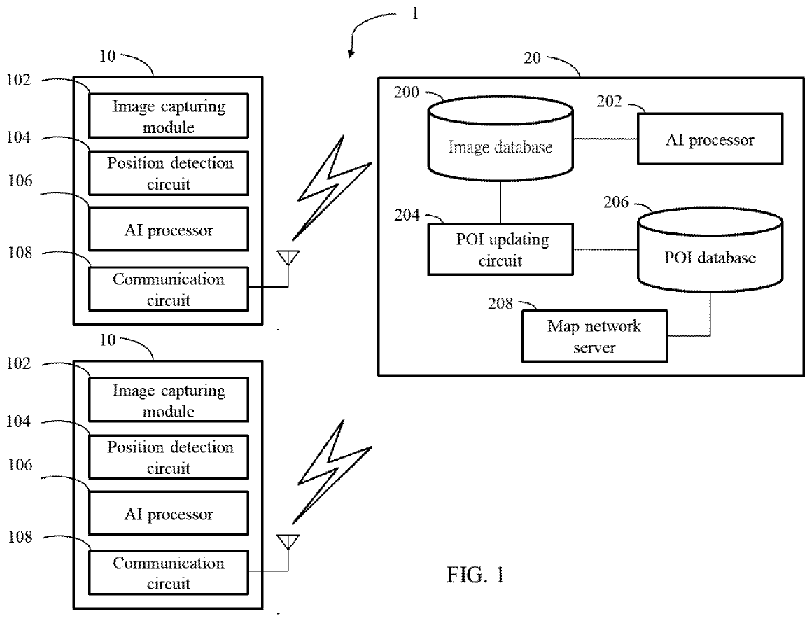

Please refer to FIG. 1, which is a schematic diagram of an electronic map system 1 capable of dynamically updating points of interest (POIs) according to an embodiment of the present invention. The electronic map system 1 includes a plurality of edge devices 10 and a cloud server device 20. Each edge device 10 may be disposed on a vehicle. For example, the vehicles equipped with the edge devices 10 may be fleet vehicles of a company's fleet. The edge device 10 may capture street view images and the location information of the street view images, and upload the captured street view images and related location information to the cloud server device 20 for storage. For example, the edge device 10 may an on board unit (OBU), a tablet, a mobile phone, a notebook or any other electronic device capable of data processing and communication. The edge device 10 includes an image capture module 102, a position detection circuit 104, an artificial intelligence (AI) processor 106 and a communication circuit 108. The image capture module 102 may be disposed on the vehicle and configured to capture images. The image capturing module 102 may be disposed at any position of the vehicle, which is capable of capturing images around the vehicle. For example, the image capturing module 102 may be a forward-facing image capturing module for capturing images of the front side of the vehicle. In an embodiment, the image capturing module 102 may be installed on a windshield of the vehicle, but not limited thereto. The image capturing module 102 may be a car recorder, a dash cam, a camera, or any other device capable of capturing images. The position detection circuit 104 may be disposed on the vehicle and configured to detect location information of the street view images. The position detection circuit 104 may include a global positioning system (GPS), a Wi-Fi positioning module, a base station positioning module and/or inertial measurement unit (IMU), but not limited thereto. Location information may include latitude, longitude, bearing, altitude and speed for indicating the location and direction of the image. The edge device 10 may transmit the captured street view images and the location information of the street view images to the cloud server device 20 through the communication circuit 108 for storage. The communication circuit 108 may be a wireless communication circuit. The communication circuit 108 may support at least one of the Wi-Fi, fifth generation mobile communication network (5G), fifth generation new radio (5G NR), fourth generation long term evolution (4G LTE), third generation mobile communication network (3G), Bluetooth, but not limited thereto.

The cloud server device 20 includes an image database 200, an AI processor 202, a POI updating circuit 204, a POI database 206 and a map network server 208. The image database 200 is utilized for storing the street view images and the location information of the street view images uploaded by the edge devices 10. The AI processor 202 includes an AI model, and is configured to analyze the street view images and the location information of the street view images uploaded by the edge devices 10 according to the AI intelligence model, so as to determine a plurality of current POIs and locations of the plurality of current POIs. The POI updating circuit 204 is coupled to the POI database 206 and configured to compare the current POIs with the original POIs and accordingly perform a POI update procedure. The POI database 206 is configured to store information of a plurality of original POIs and location information of the plurality of original POIs. The map network server 208 is configured to obtain the updated information of POIs and the location information of the PO from the POI database 2061 after the POI update procedure, and display the updated POI information on the map through the web browser.

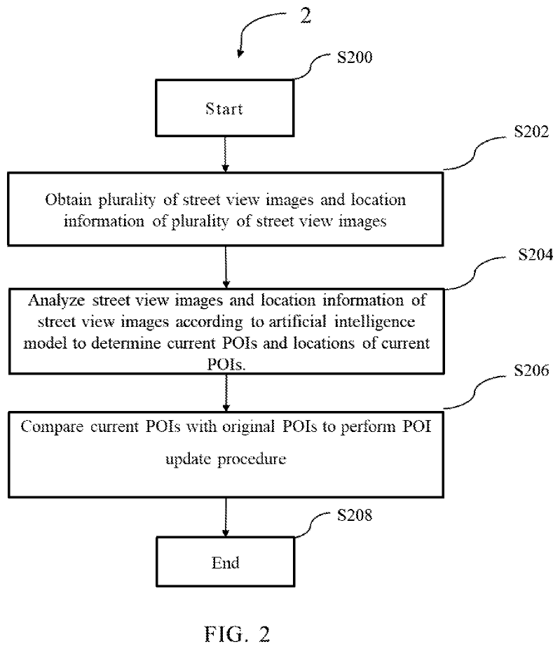

For an illustration of the operations of the electronic map system 1, please refer to FIG. 2. FIG. 2 is a flow diagram of a procedure 2 according to an embodiment of the present invention. The flowchart in FIG. 2 mainly corresponds to the operations on the electronic map system 1 shown in FIG. 1. The procedure 2 includes the following steps:
Step S200: Start.
Step S202: Obtain a plurality of street view images and location information of the plurality of street view images.
Step S204: Analyze the plurality of street view images and the location information of the plurality of street view images according to an artificial intelligence model to determine a plurality of current POIs and locations of the plurality of current POIs.
Step S206: Compare the plurality of current POIs with a plurality of original POIs to perform a POI update procedure.
Step S208: End

According to the procedure 2, in Step S202, each edge device 10 may utilize the image capture module 102 to capture street view images and utilize the position detection circuit 104 to detect location information of the street view images. After that, the edge device 10 may upload the captured street view images and related location information of the street view images to the cloud server device 20 for storage. The electronic map system 1 includes a plurality of edge devices 10. Each edge device 10 may be disposed in a vehicle. For example, vehicles equipped with the edge devices 10 may be fleet vehicles of a company's fleet (e.g., fleet of logistics company or taxis company).

In step S204, the cloud server device 20 may generate a plurality of current POIs and locations of the plurality of current POIs according to the AI model. The AI processor 202 may read the street view images and the location information of the street view images uploaded by the edge devices 10 from the image database 200. The AI processor 202 may include at least one AI model. The AI processor 202 may be configured to analyze the street view images and the location information of the street view images according to at least one AI model so as to determine a plurality of current POIs and locations of the plurality of current POIs. The plurality of current POIs and locations of the plurality of current POIs may be stored into the image database 200 by the AI processor 202. The AI processor 202 may utilize the AI model to perform object detection, image classification and image segmentation processing on the street view images to determine the plurality of current POIs and the locations of the plurality of current POIs. The object detection processing may be configured to identify and locate bounding boxes of objects in the images. The image classification processing may be configured to assign labels or classes to the street view images. The image segmentation processing may be configured to divide the street view images into a plurality of subgroups. The AI processor 202 may perform grouping operations on the bounding boxes according to the positions, colors and shapes of the bounding boxes in the image frames to determine the current POIs. Each current POI may be represented by a set of bounding boxes. The AI processor 202 may utilize an open source computer vision library (OpenCV) technique (e.g., object tracking, feature point comparison or other AI object detection processing) to group and filter bounding boxes for determining the current POIs. The current POIs and the original POIs of embodiments of the present invention may include traffic signs, traffic signals, lane markings, signboards, building appearances, and the like. The information of the current POIs and the original POIs of embodiments of the present invention may include name information, category information, and geographic location information (e.g., longitude, latitude).

In addition, if the edge device 10 has sufficient computing power, an AI processor may also be applied in the edge device 10 to retrieve a plurality of current POIs and locations corresponding to the current POIs. For example, as shown in FIG. 1, the edge device 10 includes an AI processor 106. The AI processor 106 includes an AI model, and the AI processor 106 may analyze the street view images captured by the image capture module 102 and location information detected by the location detection circuit 104 according to the AI model to determine the current POIs and location information of the current POIs. The AI processor 106 may provide the determined current POIs and location information of the current POIs to the cloud server 20.

In Step S206, the POI updating circuit 204 is configured to compare the current POIs which are retrieved from the street view images uploaded by the edge devices 10 with the original POIs stored in the POI database 206 to generate a comparison result, and perform a POI update procedure according to the comparison result for updating POI information stored in the POI database 206. After performing the POI update procedure, the map network server 208 may read the latest version of the updated POI information from the POI database 206 and display the updated POI information of the electronic map through the web browser, thereby providing the latest and most accurate POI map information for the users.

In Step S206, the information of the plurality of current POIs and the locations of the plurality of current POIs determined by the AI processor 202 may be stored into the image database 200, and the POI updating circuit 204 may read the information of the plurality of current POIs and the locations of the plurality of current POIs from the image database 200. Information of the plurality of current POIs and the locations of the plurality of current POIs determined by the AI processor 202 may also be provided to the POI updating circuit 204, such that the POI updating circuit 204 directly obtains the information of the plurality of current POIs and the locations of the plurality of current POIs from the AI processor 202. Moreover, for each current POI, the POI updating circuit 204 may compare each current POI and location of each current POI with the plurality of original POIs and locations of the plurality of original POIs stored in the POI database 206 to generate a comparison result. For example, the POI updating circuit 204 may compare the bounding boxes representing the current POI with the bounding boxes representing the original POIs to generate a corresponding comparison result. For example, when the bounding box representing the current POI matches a bounding box representing an original POI, the comparison result indicates that the current POI matches the original POI. In an embodiment, when determining that a first current POI of the plurality of current POIs is located at a first position, and a first original POI of the plurality of original POIs is also located at the first position, the POI updating circuit 204 may determine whether the POI at the same position (e.g., first position) has changed. For example, the POI updating circuit 204 compares the first current POI with the first original POI. When the first current POI matches the first original POI, this means that the first original POI at the first position has not been changed, and the first original POI stored in the POI database 206 may be preserved without replacing. In other words, when the comparison result indicates that the location of the first current POI matches the location of the first original POI and the first POI also matches the first original POI, the POI updating circuit 204 determines to reserve the first original POI in the POI database 206.

In an embodiment, when the POI updating circuit 204 determines that a first current POI of the plurality of current POIs is located at a first position and a first original POI of the plurality of original POIs is also located at the first position, the POI updating circuit 204 determines whether the POI at the same position has changed. The POI updating circuit 204 may compare the first current POI with the first original POI. When determining that the first current POI does not match the first original POI, this means that the first original POI at the first position has been changed. The POI updating circuit 204 replaces the first original POI in the POI database 206 with the first current POI to perform the POI update procedure. For example, information of the first original POI and location information of the first original POI in the POI database 206 may be removed from the POI database 206, and information of the first current POI and location information of the first current POI may be written into the POI database 206 for performing the POI update procedure. Besides, in order to ensure the correctness of the POI update procedure, the POI updating circuit 204 may continuously determine which POI is at the first location within a specific period and accordingly perform the POI update procedure. For example, when all POI determination results based on the street view images uploaded by the edge devices 10 in the past three months indicate that the first current POI is at the first location, the POI updating circuit 204 may replace the first original POI in the POI database 206 with the first current POI to perform the POI update procedure. In other words, when the comparison result indicates that the location of the first current POI matches the location of the first original POI and the first POI does not match the first original POI, the POI updating circuit 204 may replace the first original POI in the POI database 206 with the first current POI to perform the POI update procedure. As a result, the electronic map system 1 may display the current POI at the first position, thereby providing the latest and most accurate POI map information for the users.

In an embodiment, when determining that a first current POI of the plurality of current POIs is located at a first position, and none of the plurality of original POIs in the POI database 206 is located at the first position, this means that the first current POI at the first position is a new POI. The POI updating circuit 204 may add and store the first current POI and the location of the first current POI to the POI database 206 to perform the POI update procedure. Similarly, in order to ensure the correctness of the POI update procedure, the POI updating circuit 204 may continuously determine which POI is at the first location within a specific period and accordingly perform the POI update procedure. For example, when all POI determination results based on the street view images uploaded by the edge devices 10 in the past three months indicate that the first current POI is at the first location, the POI updating circuit 204 may add and store the first current POI and the location of the first current POI to the POI database 206 to perform the POI update procedure. In other words, when the comparison result indicates that the location of the first current POI does not match the locations of the plurality of original POIs, the POI updating circuit 204 may add and store the first current POI and the location of the first current POI to the POI database 206 to perform the POI update procedure.

In an embodiment, when determining that a first original POI of the plurality of current POIs is located at a first position, and none of the plurality of current POIs is located at the first position, this means that first original POI has disappeared. The POI updating circuit 204 may remove the first original POI from the POI database 206 to perform the POI update procedure. In other words, when the comparison result indicates that the location of the first original POI does not match the locations of the plurality of current POIs, the POI updating circuit 204 may remove the first original POI and the location information of the first original POI in the POI database 206 to perform the POI update procedure. Similarly, in order to ensure the correctness of the POI update procedure, the POI updating circuit 204 may continuously determine which POI is at the first location within a specific period and accordingly perform the POI update procedure. For example, when all POI determination results based on the street view images uploaded by the edge devices 10 in the past three months indicate that none of the plurality of current POIs is located at the first position, the POI updating circuit 204 may remove first original POI at the first location and the location information of the first original POI in the POI database 206 to perform the POI update procedure.

For example, when a convenience store has been relocated from a first location to a second location and a signboard of the convenience store has also been relocated from the first location to the second location. Taking the signboard of the convenience store as a POI for example, if the POI database 206 currently stores the POI information before the store relocation, that is, the POI database 206 stores a first original POI at the first position (e.g., signboard of the convenience store at the first position) at present. When a vehicle equipped with an edge device 10 passes by the convenience store located at the second location, the image capturing module 102 of the edge device 10 captures the street view image and the location detection circuit 104 of the edge device 10 detects the location information of the street view image, and the captured street view image and the location information of the captured street view image may be uploaded to the cloud server 20. The AI processor 202 analyzes and processes the captured street view image and the location information of the captured street view image and accordingly determines that a first current POI (e.g., the signboard of the convenience store) located at the second position. The updating circuit 204 compares the first current POI at the second position with all the original POIs stored in the POI database 206, and the comparison result indicates none of the original POIs at the second position, this means that the first current POI located at the second position is a new POI. The POI updating circuit 204 adds the first current POI (e.g., the signboard of the convenience store) at the second position to the POI database 206. Further, when a vehicle equipped with the edge device 10 passes by the first location, the image capturing module 102 of the edge device 10 captures the street view image and the location detection circuit 104 of the edge device 10 detects the location information of the street view image, and the captured street view image and the location information of the captured street view image may be uploaded to the cloud server 20 for storage. The AI processor 202 analyzes and process the captured street view image and the location information of the captured street view image and accordingly determines that no current POI is located at the first position. This means that the original POI at the first position stored in the POI database 206 is a disappeared POI. The POI updating circuit 204 may remove the information of the first original POI in the POI database 206 to perform the POI update procedure, thereby providing the latest and most accurate POI map information for the users.

Those skilled in the art should readily make combinations, modifications and/or alterations on the abovementioned description and examples. The abovementioned description, steps, procedures and/or processes including suggested steps can be realized by means that could be hardware, software, firmware (known as a combination of a hardware device and computer instructions and data that reside as read-only software on the hardware device), an electronic system or combination thereof. Examples of hardware can include analog, digital and/or mixed circuits known as microcircuit, microchip, or silicon chip. Examples of the electronic system may include a system on chip (SoC), system in package (SiP), a computer on module (COM), and the electronic map system 1. Any of the above-mentioned procedures and examples above may be compiled into program codes or instructions that are stored in a storage device. The storage device may include a computer-readable storage medium. The storage device may include read-only memory (ROM), flash memory, random access memory (RAM), subscriber identity module (SIM), hard disk, floppy diskette, or CD-ROM/DVD-ROM/BD-ROM, but not limited thereto. The processing circuit may read and execute the program codes or the instructions stored in the storage device for realizing the above-mentioned functions. Each of the AI processor 106, the AI processor 202, the POI updating circuit 204 and the processing circuit may be a central processing unit (CPU), a microprocessor, a digital signal processor (DSP), a programmable controller, a graphics processing unit (GPU), a programmable logic device (PLD), an electronic control unit (ECU) or other similar devices or combination of these devices, but not limited thereto.

In summary, the embodiments of the present invention may use the street view images and location obtained by the edge devices to real time and dynamically update the POI information in the electronic map through the cloud server device so as to provide the latest and most accurate POI information, thus effectively improving the accuracy of navigation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of dynamically updating points of interest (POIs), applied to an electronic map system, comprising:
obtaining a plurality of street view images captured by a plurality of edge devices and location information of the plurality of street view images;
analyzing the plurality of street view images and the location information of the plurality of street view images according to an artificial intelligence (AI) model to determine a plurality of current POIs and locations of the plurality of current POIs; and
comparing the plurality of current POIs with a plurality of original POIs stored in a POI database of the electronic map system to perform a POI update procedure.

2. The method of dynamically updating POIs of claim 1, wherein the step of comparing the plurality of current POIs with the plurality of original POIs stored in the POI database of the electronic map system to perform the POI update procedure comprises:
for each current POI, comparing the current POI and location of the current POI with the plurality of original POIs and the locations of the plurality of original POIs stored in the POI database of the electronic map system to generate a comparison result for performing the POI update procedure.

3. The method of dynamically updating POIs of claim 2, further comprising:
when the comparison result indicates that a location of a first current POI of the plurality of current POIs matches a location of a first original POI of the plurality of original POIs and the first POI does not match the first original POI, replacing the first original POI in the POI database with the first current POI to perform the POI update procedure.

4. The method of dynamically updating POIs of claim 2, further comprising:
when the comparison result indicates that a location of a first current POI of the plurality of current POIs matches a location of a first original POI of the plurality of original POIs and the first POI matches the first original POI, determining to reserve the first original POI in the POI database.

5. The method of dynamically updating POIs of claim 2, further comprising:
when the comparison result indicates that a location of a first current POI of the plurality of current POIs does not match the locations of the plurality of original POIs, adding the first current POI and the location of the first current POI to the POI database to perform the POI update procedure.

6. The method of dynamically updating POIs of claim 2, further comprising:
when the comparison result indicates that a location of a first original POI of the plurality of current POIs does not match the locations of the plurality of current POIS, removing the first original POI in the POI database to perform the POI update procedure.

7. An electronic map system, comprising:
a plurality of edge devices, each edge device disposed on a vehicle and configured to capture street view images and location information of the plurality of street view images;
a cloud server device, comprising:
an image database, configured to store a plurality of street view images and location information of the plurality of street view images uploaded by the plurality of edge devices;
a POI database, configured to store a plurality of original POIs and location information of the plurality of original POIs;
an AI processor comprising an AI model, and configured to analyze the plurality of street view images and the location information of the plurality of street view images uploaded by the plurality of edge devices according to the AI model to determine a plurality of current POIs and locations of the plurality of current POIs store a plurality of street view images; and
a POI updating circuit, coupled to the POI database and the AI processor, and configured to compare the plurality of current POIs with the plurality of original POIs to perform a POI update procedure.

8. The electronic map system of claim 7, wherein for each current POI, the POI updating circuit id configured to compare the current POI and location of the current POI with the plurality of original POIs and the locations of the plurality of original POIs to generate a comparison result for performing the POI update procedure.

9. The electronic map system of claim 8, wherein when the comparison result indicates that a location of a first current POI of the plurality of current POIs matches a location of a first original POI of the plurality of original POIs and the first POI does not match the first original POI, the POI updating circuit is configured to replace the first original POI in the POI database with the first current POI to perform the POI update procedure.

10. The electronic map system of claim 8, wherein when the comparison result indicates that a location of a first current POI of the plurality of current POIs matches a location of a first original POI of the plurality of original POIs and the first POI matches the first original POI, the POI updating circuit is configured to determine to reserve the first original POI in the POI database.

11. The electronic map system of claim 8, wherein when the comparison result indicates that a location of a first current POI of the plurality of current POIs does not match the locations of the plurality of original POIs, the POI updating circuit is configured to add the first current POI and the location of the first current POI to the POI database to perform the POI update procedure.

12. The electronic map system of claim 8, wherein when the comparison result indicates that a location of a first original POI of the plurality of current POIs does not match the locations of the plurality of current POIs, the POI updating circuit is configured to remove the first original POI in the POI database to perform the POI update procedure.

13. A cloud server device, comprising:
an image database, configured to store a plurality of street view images and location information of the plurality of street view images uploaded by a plurality of edge devices;
a POI database, configured to store a plurality of original POIs and location information of the plurality of original POIs;
an AI processor comprising an AI model, and configured to analyze the plurality of street view images and the location information of the plurality of street view images uploaded by the plurality of edge devices according to the AI model to determine a plurality of current POIs and locations of the plurality of current POIs store a plurality of street view images; and
a POI updating circuit, coupled to the POI database and the AI processor, and configured to compare the plurality of current POIs with the plurality of original POIs to perform a POI update procedure.

14. The cloud server device of claim 13, wherein for each current POI, the POI updating circuit is configured to compare the current POI and location of the current POI with the plurality of original POIs and the locations of the plurality of original POIs to generate a comparison result for performing the POI update procedure.

15. The cloud server device of claim 14, wherein when the comparison result indicates that a location of a first current POI of the plurality of current POIs matches a location of a first original POI of the plurality of original POIs and the first POI does not match the first original POI, the POI updating circuit is configured to replace the first original POI in the POI database with the first current POI to perform the POI update procedure.

16. The cloud server device of claim 14, wherein when the comparison result indicates that a location of a first current POI of the plurality of current POIs matches a location of a first original POI of the plurality of original POIs and the first POI matches the first original POI, the POI updating circuit is configured to determine to reserve the first original POI in the POI database.

17. The cloud server device of claim 14, wherein when the comparison result indicates that a location of a first current POI of the plurality of current POIs does not match the locations of the plurality of original POIs, the POI updating circuit is configured to add the first current POI and the location of the first current POI to the POI database to perform the POI update procedure.

18. The cloud server device of claim 14, wherein when the comparison result indicates that a location of a first original POI of the plurality of current POIs does not match the locations of the plurality of current POIs, the POI updating circuit is configured to remove the first original POI in the POI database to perform the POI update procedure.
